(19) United States
(12) Patent Application Publication
(10) Pub. No.: US 2017/0191558 A1
(43) Pub. Date: Jul. 6, 2017

(54) DRIVETRAIN SYSTEM AND USE THEREOF

(71) Applicant: MIRANDA & IRMACO, LDA., Agueda (PT)

(72) Inventor: Joao Filipe TAVARES MIRANDA, Agueda (PT)

(21) Appl. No.: 15/312,889

(22) PCT Filed: Oct. 9, 2014
(86) PCT No.: PCT/IB2014/065169

§ 371 Date: Nov. 21, 2016

(30) Foreign Application Priority Data
May 29, 2014 (PT) 107666

(51) Int. Cl. F16H 55/30; F16H 7/06; F16H 55/08; B62M 9/06; B62M 9/10

(52) U.S. Cl. CPC F16H 55/30; B62M 9/06; B62M 9/10; F16H 55/08; F16H 7/06

(57) ABSTRACT

The present application describes a drivetrain system which includes a sprocket tooth profile and use thereof. This drivetrain system enables improved guidance of the chain (2) through the use of a non-standard tooth profile (1) so that when a rear gearbox is used it is possible to have a single speed in the chainset. This drivetrain system is utilised in vehicles, preferably bicycles.

### TECHNICAL FIELD

The present application discloses a drivetrain system which includes a sprocket tooth profile and use thereof.

### PRIOR ART

With the introduction of chain drivetrain systems where a rear derailleur is used and a single speed on the chainset in bicycles, it became extremely important to ensure optimum performance of the guidance system of the chain in the chainset so as to avoid ungearing.

This technical problem has complex resolution given that the chain undergoes a considerable and never constant deviation.

The known state-of-the-art systems for traction in bicycles, particularly when the chain is submitted to a particular deviation when rear derailleurs and cassettes are used and a single-speed in the chainset, cannot ensure good gearing, may be noisy, and may even lead to ungearing of the chain in this situation which in no way contributes to user comfort and safety.

In standard sprocket systems for bicycle chains, wherein the chain is subject to deviations, the system cannot ensure good and continuous gearing due to the existing clearance on the top of the tooth and to the distance between rollers which means that when a chain deviates from the teeth, it touches the lateral chain plates at the start of gearing and not the rollers.

Also systems designated as “Narrow wide teeth” are known in the art, such as those disclosed in U.S. Pat. No. 4,174,642 and US201113311735, wherein chain guidance is made laterally on the chain plates. This solution leads to notable wear of the sprocket due to the considerable friction of the chain plates on the sprocket teeth lateral side, which means that after a certain period of use and due to the friction between the sprocket and the chain plates, guidance may become seriously compromised. Due also to this friction, the chain does not have the necessary fluidity when gearing leading to considerable waste of energy, which is especially important in competition situations.

U.S. Pat. No. 5,876,296 A discloses a set of toothed wheels comprising a small sprocket and a large sprocket coaxial with the small pinion. The pinion is provided with an axially-oriented recess in the bottom portion located between the first tooth and the second tooth of the pinion. The recess has a supporting curved face extending from the second tooth. The pinion is further provided with a supporting protrusion located under the supporting curved face such that the supporting protrusion is separated from the supporting curved face by a distance corresponding to about one tooth pitch. The supporting curved face and the supporting protrusion act to support the inner and the outer chain plates of a drive chain at such time when the gear shifting takes place. On the contrary, the technical problem which the solution herein disclosed seeks to resolve is a completely different one, especially that of improving the guidance of the chain in situations where the vibration thereof is very high. In addition, the technical solution herein disclosed is significantly different from the technical solution presented in this document as a result of the reading thereof.

EP1489338 A2 discloses a roller chain sprocket including a plurality of teeth alternating with furrows at an equal pitch. Each tooth and each furrow are designed in a manner such that a chain roller comes into contact with only a pressure transmitting flank of the tooth, or only the pressure transmitting flank and a flank of an adjacent tooth facing the pressure transmitting flank for preventing the roller from contacting a furrow bottom when the sprocket transmits a driving force to and receives a driving force from the roller chain. On the contrary, the technical solution disclosed herein is significantly different from the technical solution presented in this document as a result of the reading thereof.

### SUMMARY

The present application describes a drivetrain system comprising:
a sprocket with a non-standard tooth profile which has a height greater than 7.5 mm;
two lateral curvatures, for each tooth, at a tangent to the respective laterals and with a height greater to that of half of the height of the chain plates.

In one embodiment, the height of the tooth profile used in the drivetrain system is between 7.5 and 12 mm.

In another embodiment, the height of the tooth profile used in the drivetrain system is between 7.5 and 7.8 mm.

In another embodiment, the roller passage radius and first guidance used in the drivetrain system is greater than 0.3 mm.

Still in another embodiment, the radius for the start of accommodation in the roller for the drivetrain system is at a tangent to the intermediate radius.

In another embodiment, the radius for the start of accommodation of the roller used in the drivetrain system is greater than 20 mm.

In another embodiment, the smoothing radius used in the drive train system is tangential to the intermediate ratio and to the roller accommodation start ratio.

Still in another embodiment, the intermediate radius used in the drivetrain system is less than 10.5 mm.

In one embodiment, the gearing radius used in the drivetrain system is greater than 3.5 mm.

In another embodiment, the thickness of the tooth top used in the drivetrain system is less than 1.2 mm.

Still in another embodiment, the thickness of the tooth bottom in the drivetrain system is between 1.6 and 3.0 mm.

In one embodiment, the sprocket guidance used in the drivetrain system is carried out through the rollers.

The present application also discloses a vehicle comprising the drivetrain system described above.

Finally, the present application also discloses a bicycle comprising the drivetrain system described above.

### GENERAL DESCRIPTION

The present application describes a drivetrain system which enables improved guidance of the chain (2) through the use of a non-standard tooth profile (1) so that when a rear gearbox is used it is possible to have a single speed in the chainset.

Throughout the present text a non-standard tooth profile (1) is considered as a tooth profile wherein the dimensions, specifically the height, weight and depth, are not suitably standardised. In this way, the dimensions used are outside the intervals considered usual and/or the values achievable through constructions obtained through CAD software.

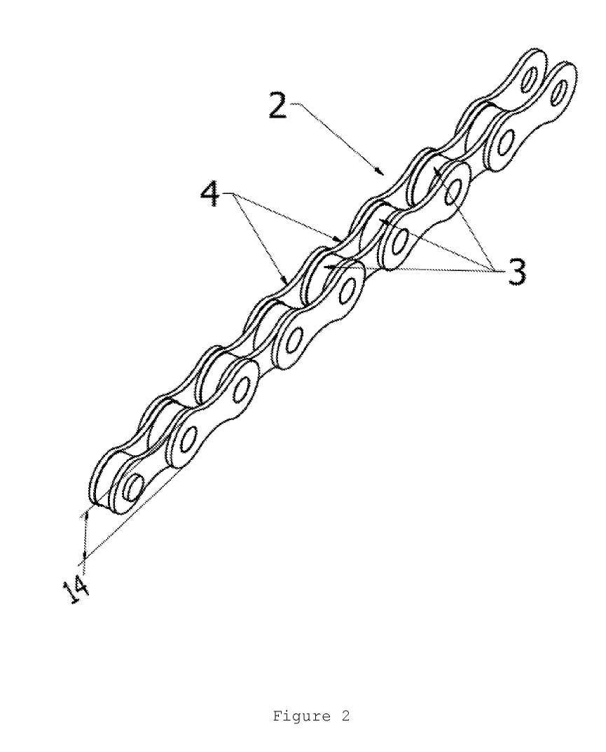

In case of varying speeds in the rear axle and a single speed in the chainset, this leads to the chain (2) undergoing major deviation mainly when the changes take place at the end-points of the cassette. Due to this fact a reinforced guidance for the chain (2) is necessary in the sprocket of the chain set, as illustrated in FIG. 2, so as to avoid the chain (2) disengaging itself and so that the traction fluidity is improved, thus enabling the chain (2) to function in a smooth manner. In this way the noise caused by the gearing of the chain in the sprocket, as well as the loss of energy due to friction are reduced. This guidance is more important as the oscillation to which the chain is subjected is greater.

As such, this technology has the following advantages in relation to prior art drivetrain systems:
Better chain guidance (2) wherein a rear derailleur and cassette in the rear axle and a single speed in the chain set are used;
Constant guidance in the chain (2) rollers (3) and not in the side chain plates (4) which provides smooth and precise gearing;
Less friction between the chain (2) and the sprocket;
Less lateral wear in the sprocket;
Greater energy efficiency with fewer energy losses due to friction;
Less noise in all situations especially situations involving greater chain deviation (2);
Less wear on the side area of the sprocket (5).

The technical solution disclosed herein has special application for off-road bicycles, rear suspension bicycles, toothed wheels of electrical bicycles and for any other application where oscillation of the chain is a very important and significant variable.

### DESCRIPTION OF THE FIGURES

Figures are herein attached for a better understanding of the art, which show preferred embodiments and which are however not intended to limit the scope of the present application.

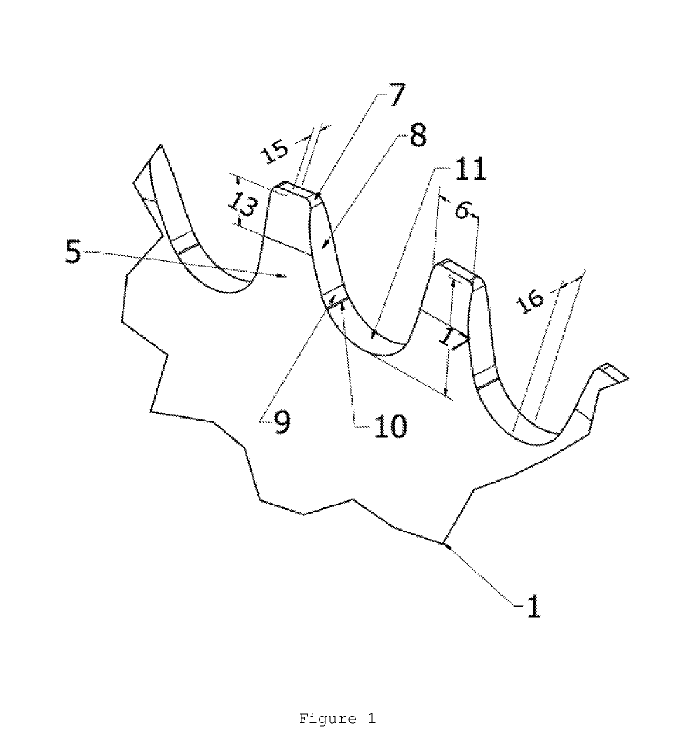

FIG. 1 schematically illustrates a view of a non-standard sprocket profile, wherein the reference numbers indicate:
1—Non-standard tooth profile;
5—Lateral side of the sprocket;
6—Width of tooth top;
7—Roller passage radius and first guidance;
8—Radius of roller accommodation start;
9—Smoothing radius;
10—Intermediate radius;
11—Gearing radius;
13—Height of the lateral radii;
15—Thickness of the tooth top;
16—Thickness of tooth bottom;
17—Tooth height.

FIG. 2 schematically illustrates a perspective view of the chain, wherein the reference numbers indicate:
2—Chain;
3—Rollers;
4—Lateral current plates;
14—Chain plate height.

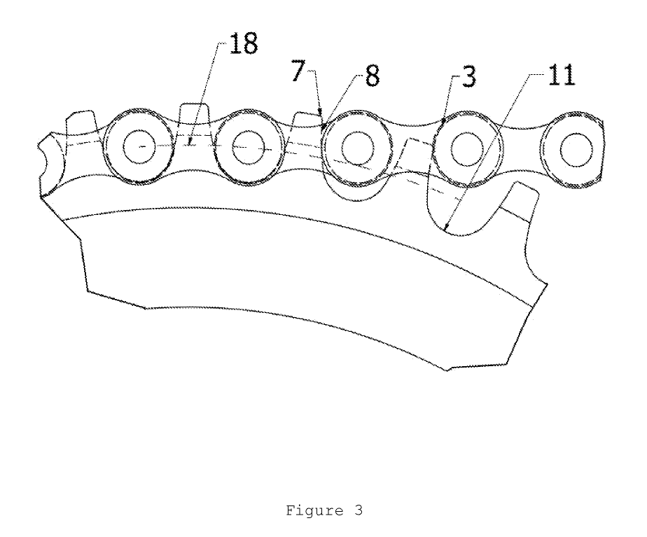

FIG. 3 schematically illustrates a gearing of the chain on the sprocket, wherein the reference numbers indicate:
3—Rollers;
7—Roller passage radius and first guidance;
8—Radius of roller accommodation start;
11—Gearing radius;
18—Primitive radius.

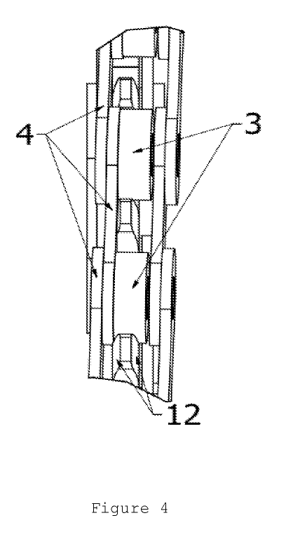

FIG. 4 schematically illustrates a chain with deviation on the sprocket, wherein the reference numbers indicate:
3—Rollers;
4—Lateral current plates;
12—Lateral curvature.

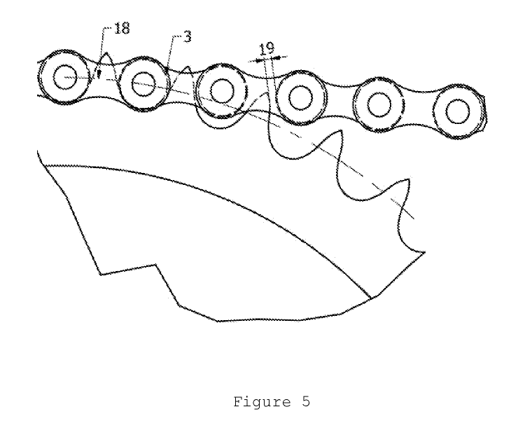

FIG. 5 schematically illustrates the gearing of a chain with standard profile, wherein the reference numbers indicate:
3—Rollers;
18—Primitive radius.
19—Clearance between roller and top of the sprocket profile.

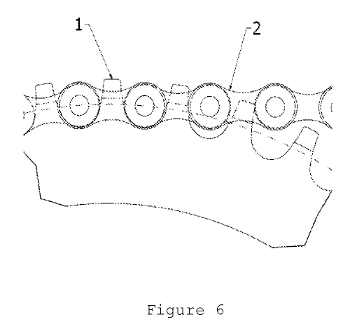

FIG. 6 schematically illustrates a perspective view of the chain, wherein the reference numbers indicate:
1—Non-standard tooth profile;
2—Chain.

### DESCRIPTION OF EMBODIMENTS

The present application describes a drivetrain system comprising a non-standard tooth profile (1), allowing for an improved guidance in the chain (2) so that when a rear gearbox is used a single speed in the chainset is made possible.

This technology provides for a drivetrain system comprising a sprocket which enables better guidance and gearing of the chain (2). The sprocket tooth profile used is not standard, i.e. its geometrical construction is not based on any standard or “CAD” book.

In one embodiment, the system comprises a sprocket tooth profile type which has a tooth height (17) greater than the standard tooth profile height so that the gearing start occurs as quickly as possible. This feature enables the system to start implementing the long guidance immediately before the roller reaches the gearing point.

The height of the tooth used in the drivetrain system should be greater than 7.5 mm, preferably between 7.5 mm and 12.0 mm. In one embodiment where a low number of teeth is used in the sprocket and wherein the chain has been considerably tightened, the height of the tooth should be between 8.0 mm and 12.0 mm. However, where the embodiment comprises a low number of teeth in the sprocket but wherein a low quality chain is used which cannot achieve such tightening, the height of the tooth should be between 7.8 mm and 12.0 mm. In another embodiment where a high number of teeth is used in the sprocket and the chain has been considerably tightened, the height of the tooth should be between 8.5 mm and 12.0 mm. However, where the embodiment comprises a high number of teeth in the sprocket but wherein a low quality chain is used which cannot achieve such tightening, the height of the tooth should be between 8.3 mm and 12.0 mm. Still in another embodiment, the height of the tooth may be between 7.5 mm and 7.8 mm in the cases where the pressure to be applied in the chain is not so high.

The sprocket tooth may have a tooth top width (6) such that at the posterior gearing point, the tooth top starts the guidance phase on the chain (2) roller (3) much earlier than in the case of a standard sprocket. This thus allows for the correct gearing in the roller (3) which is a revolving element of the chain (2), thus also ensuring low wear on the sprocket since there is a reduction in the friction between the sprocket and the chain (2). This tooth top width (6) should be greater than 3 mm, preferably between 3 and 4 mm.

The roller passage radius and first guidance (7) should function so as to immediately allow a first guidance and leave the next roller free for gearing. This roller passage radius and first guidance (7) should be greater than 0.3 mm, preferably between 0.3 and 1 mm.

The roller accommodation start (8), where the first roller (3) accommodation of the chain (2) is carried out and wherein the roller (3) starts to be directed to the tooth bottom should be at a tangent to the intermediate radius (10) in order to ensure smooth dislocation of the chain (2). This roller accommodation start (8) should be greater than 20 mm, preferably between 20 and 200 mm.

The smoothing radius (9) which has the function of directing the chain (2) to the intermediate radius (10) should be at a tangent to this same intermediate radius (10) and to the roller accommodation start radius (8) so that the path of the chain (2) is smooth.

The intermediate radius (10) has the function, at the moment of the traction, of keeping the chain (2) housed in the gearing radius zone (11) which will house the roller (3) of the chain (2), thus gearing the system. This intermediate radius (10) should be less than 10.5 mm, preferably between 1.0 and 10.5 mm.

The centre of the intermediate radius (10) may be the interception of the centre line which passes through the centre of the gearing radius (11) with the primitive radius line (18). The gearing radius (11) should be greater than 3.5 mm, preferably between 3.5 and 5.0 mm.

The system should also comprise two lateral curvatures (12) in each sprocket tooth so that the chain (2) smoothly enters in the tooth when there is a deviation. This radius is at a tangent to the sprocket lateral (5) and has the height of the lateral radii (13) greater than half of the height of the chain plates (14). In this way the chain engages the gear smoothly, and there is a reduction in the lateral friction.

The tooth top thickness (15) ensures that even if the chain (2) has a deviation it will enter the sprocket profile. This tooth top thickness (15) should be less than 1.2 mm, preferably between 0.5 and 1.2 mm.

The tooth bottom thickness (16) enables the chain (2) to be geared only by the roller (3) and not just by the lateral plates. This thickness of the tooth bottom (16) is between 1.6 and 3.0 mm.

All radii of the geometrical construction of the system are at tangents to each other so as to ensure the smoothness of the system. This entire construction aims at reducing the clearance between roller and top of the sprocket (19) profile in the state of the art solutions thus allowing the chain (2) to be geared by the rollers (3) and/or by the lateral chain plates (4).

FIGS. 5 and 6 illustrate show how the gearing of the bicycle chain is achieved, making note that the existence of a non-standard tooth profile, in particular with a more raised height, enables a faster and more correct guidance for the chain. In this way it is possible to obtain a system of sprockets which avoids lateral chain support thus contributing to it being more difficult for the aforementioned chain to jump out of the system.

One way of obtaining an embodiment of this technology would be through a machining process through cutting tools using a CNC milling machine for the embodiment of the non-standard tooth profile (1) while the lateral radii would be made through a CNC lathe. Another way of obtaining this would be through a forging process.

The present embodiment is not, of course, in any way restricted to the embodiments described in this document and a person with average skill in the art may envisage many modification possibilities thereof without departing from the general idea, such as is defined in the claims.

The preferential embodiments described above are obviously able to be combined with each other. The following claims further define preferential embodiments.

1. Drivetrain system comprising:
a sprocket with a non-standard tooth profile which has a height greater than 7.5 mm;
two lateral curvatures, for each tooth, at a tangent to the respective laterals and with a height greater to that of half of the height of the chain plates.

2. Drivetrain system according to claim 1, wherein the height of the tooth profile is between 7.5 and 12.0 mm.

3. Drivetrain system according to claim 1, wherein the height of the tooth profile is between 7.5 and 7.8 mm.

4. Drivetrain system according to claim 1, wherein a roller passage radius and a first guidance is greater than 0.3 mm.

5. Drivetrain system according to claim 1, wherein a radius of a roller accommodation start is at a tangent to an intermediate radius.

6. Drivetrain system according to claim 5, wherein the radius of the roller accommodation start is greater than 20 mm.

7. Drivetrain system according to claim 5, wherein a smoothing radius is at a tangent to the intermediate radius and to the radius of the roller accommodation start.

8. Drivetrain system according to claim 5, wherein the intermediate radius is less than 10.5 mm.

9. Drivetrain system according to claim 1, wherein a gearing radius is greater than 3.5 mm.

10. Drivetrain system according to claim 1, wherein the thickness of the tooth top is less than 1.2 mm.

11. Drivetrain system according to claim 1, wherein the thickness of the tooth bottom is between 1.6 and 3.0 mm.

12. Drivetrain system according to claim 1, wherein the sprocket guidance is carried out through rollers.

13. Vehicle comprising the drivetrain system according to claim 1.

14. Bicycle comprising the drivetrain system according to claim 1.
